(19) United States
(12) Patent Application Publication
(10) Pub. No.: US 2024/0424972 A1
(43) Pub. Date: Dec. 26, 2024

(54) HYBRID DELIVERY SYSTEM

(71) Applicant: MLY TECHNIX CORP, Campbell, CA (US)

(72) Inventors: George G. Moser, Santa Clara, CA (US); Carol Moser, Raleigh, NC (US); Joseph BINOY, San Jose, CA (US)

(21) Appl. No.: 18/821,676

(22) Filed: Aug. 30, 2024

Related U.S. Application Data
(63) Continuation-in-part of application No. 18/161,050, filed on Jan. 28, 2023.
(60) Provisional application No. 63/535,394, filed on Aug. 30, 2023.

(51) Int. Cl. B60P 3/00; B25J 5/00; B64U 10/16; B64U 70/93; B64U 101/64

(52) U.S. Cl. CPC B60P 3/007; B25J 5/007; B64U 10/16; B64U 70/93; B64U 2101/64

(57) ABSTRACT

A hybrid integrated package delivery system is disclosed. A delivery vehicle has an open cargo area into which one or more cribs can be removably installed. The cribs are pre-loaded with packages. A package handling robot is installed within the vehicle, or within each crib, and can operate to transport packages from a crib to a delivery drone during transit of the vehicle to a delivery location. A delivery drone can be piloted by a delivery vehicle driver for last yard package delivery.

The present invention is a continuation-in-part of prior pending U.S. patent application Ser. No. 18/161,050, filed on Jan. 28, 2023, titled ROBOT LOGISTICS SYSTEM, the entire contents of which are incorporated herein by reference. This application also claims priority of U.S. Provisional Patent Application 63/535,394, titled Hybrid Delivery System, filed on Aug. 30, 2023, the entire contents of which are also incorporated herein by reference.

### FIELD OF THE INVENTION

The present invention relates to the fields of ecommerce automation, robotics, general distribution of goods and logistics.

### BACKGROUND

Certain existing systems aim to automate the delivery of goods in ecommerce and general goods handling/distribution. Most of those propose solutions that use complete automation to eliminate the human role in the delivery process, such as self-driving vehicles. Despite high expectations and despite great advances in Robotics and Artificial Intelligence, such systems have largely failed to materialize until now and the pilot projects have generally been discontinued, due to unexpected problems that have surfaced and impeded implementation. These include systems relying on fully automated self-driving vehicles, which still face obstacles. While not impossible in the longer term, self-driving may not currently meet regulatory and safety requirements, and it is unclear when and whether those requirements can be met in the future. The problem of self-driving proved exceedingly complex, with many technical, safety, regulatory and community acceptance issues.

Existing systems include several attempts to automate the delivery process, some of which are described herein below.

U.S. Pat. No. 11,442,419 B2 (Heinla et all) discloses a small wheeled mobile robot configured for vending consumable items, covered with a lid. This robot cannot open doors, which limits its practicality. A customer places an order, pays with a credit card and the robot goes to meet the customer at an agreed meeting point. The customer has to open the lid and retrieve the food and/or drinks from the inside of the robot. This type of delivery relies on the customer for part of the delivery. Customer presence is required. One of the major shortcomings is the inconvenience of having to wait for the robot to arrive, since the robot is not able to deliver by itself. The customer has to wait for the robot, which some customers don't like. Scalability is limited because of the small size of the compartment for the items being delivered. The public and authorities may also not be accepting of sharing sidewalks and neighborhoods with numerous robots.

U.S. Pat. No. 11,507,100 B2 (Sibley) discloses a robot delivery system to deliver an article from a first location to a second location, which includes a transport mechanism for presenting the article to be dispensed to a recipient. The availability of a dispensing mechanism is to some extent an improvement compared to the previous patent. However, the dispensing mechanism is of high complexity and the capacity of the system is rather small, which would be an obstacle to scalability.

U.S. Pat. No. 11,518,291 B2 (Buttolo) discloses a self-driving autonomous delivery vehicle that relies on the recipient of the delivery to pick it up, but to prevent that the wrong package is picked up, the vehicle selectively unlocks the correct compartment and keeps all other compartments locked. It may not be effective at scale, only for small shipments. The packages are not completely delivered, they are presented to the customer, who is expected to retrieve them from the vehicle. Many customers are generally not willing or able to be waiting for the delivery of goods at a certain time in a certain location.

Pub. US 2022/0396192 A1 (Paul et al) discloses a complete Automated Storage and Retrieval System (such as those used in some warehouses) built into the cargo area of a delivery truck. The cargo area is full of drawers containing the packages. The packages must be loaded into the truck through a receiving station in the rear of the truck one by one, and a robot and/or conveyor system takes them to another location in the vehicle, where a second robot picks them up and stores it into a lockable drawer. At retrieval time, a third robot (or the same second robot) searches for the package to be retrieved and puts it on a conveyor belt, which sends it to the driver in the front of the vehicle. There are several issues: the time needed to load the packages into the vehicle will keep the vehicle grounded for a long time, hurting efficiency, one of the biggest known deficiencies of the current delivery systems in ecommerce. The cargo area full of drawers is not readily accessible for repairs or malfunction resolution when drawers malfunction, which will happen inevitably. The number of robots and conveyor belts operating inside the vehicle is also problematic, because the vehicle is full of drawers, and there is not enough space available for robots or conveyors to operate, considering that to function they must rotate, move and extend, with a large working envelope. Also, such a structure would be very expensive, unreliable, very hard to maintain/repair and impractical due to excessive complexity. This is a substantially different structure from the delivery vehicle of the present disclosure and it doesn't meet the basic requirements of a simple, highly reliable, easy to maintain system for the ecommerce industry.

Pub. US 2022/0281371 A1 (Meador) discloses an autonomous delivery vehicle with an internal conveyor that selectively presents the package to be delivered to a recipient, who retrieves it from the vehicle. It is suitable for a small number of packages (approximately 10 packages per vehicle) and the conveyor system could potentially work in some niche applications, but this solution falls short of the needs for ecommerce package delivery at scale (typically over 300+packages per vehicle).

U.S. Pat. No. 10,457,392 B1 (Evans et al, 2019) proposes an interesting concept for the creation of networks of mobile bases for delivering items from the mobile bases to the delivery locations via drones, utilizing an opening in the roof of the mobile base to extract the goods. A very thorough logic analysis of the network operation is provided in the patent, which would facilitate the software development for such network. The concept is not specific with regard to the system for picking parts from the mobile base and making them available to the drones.

U.S. Pat. No. 10,514,690 B1 (Siegel et al, 2019) discloses a cooperative arrangement between two or more autonomous vehicles to deliver an item, such as an autonomous ground-based vehicle transporting an item to a transfer location where an aerial vehicle would take over the item and deliver it.

U.S. Pat. No. 10,532,885 B1 (Brady et al, 2020) discloses the concept of small autonomous vehicles that travel fully autonomously (no driver) to the delivery location where they can dispense the items. The small autonomous vehicles can also be loaded in a large truck and transported to the delivery location or nearby. The autonomous vehicles may have a 3D printer to manufacture some of the needed items on location.

U.S. Pat. No. 10,671,094 B2 (Kimchi et al, 2020) discloses a virtual safety shroud to detect if any object gets in the proximity of a drone and stops the propeller. U.S. Pat. No. 10,780,988 B2 (Buchmueller et al, 2020) discloses a system to stop a propeller in case of contact or imminent contact with an object (for safety reasons). U.S. Pat. No. 10,706,382 B2 (Gil, 2020) discloses a delivery vehicle including a roof-based drone system and a picking system based on conveyor belts and shelves inside the vehicle.

U.S. Pat. No. 11,568,508 B2 (High et al, 2023) discloses a merchandise delivery vehicle based on an arrangement of autonomous ground vehicles and unmanned aerial vehicles, cooperating with each other.

Despite the foregoing efforts, hurdles of safety, noise, regulation and others remain unresolved. As a result of those obstacles, last mile delivery remains a costly, largely manual process. Embodiments described herein may address these challenges and others in a novel and pragmatic way.

### SUMMARY

A Hybrid Delivery System (HDS) is a system for automatically sorting, loading, picking and delivering packages that integrates human workers and robotic systems, enabling interactive cooperation between human labor and robotic labor. HDS does not require complete eradication of human labor from the delivery process; instead HDS combines human labor and robot labor in optimal, pragmatic ways by using the best qualities from each type of labor, with outcomes that can be even better than 100% automation, while avoiding certain regulatory, safety and other issues.

The term “hybrid” refers to the integration of both human and robotic labor. Another reason to use the term hybrid is that HDS is not just an aerial solution, it supports both aerial locomotion and ground locomotion.

HDS can also greatly facilitate, enrich and upgrade the jobs of human workers, contributing to higher job satisfaction, retention, loyalty and harmony, which can translate not only into better financial outcomes for service operators but also into a positive reputation and good-will for the company as a good corporate citizen.

HDS keeps in place the well-proven concept of the delivery truck to take the packages from the distribution center to customer homes. An electric truck is preferred but a traditional Diesel or gasoline powered is also perfectly usable, especially during the transition period. This compatibility makes it possible to very easily and inexpensively convert existing fleets of traditional delivery trucks to HDS trucks (electric or combustion-based) for quick implementation.

In an exemplary embodiment, the division of labor between humans and robots works like this:
a) the delivery truck is driven by a human driver to the delivery location (human labor);
b) the packages to be delivered at the next location are selectively picked from the cargo area by the truck's Package Retrieval Robot, typically while the truck is traveling to that delivery location (robotic labor), generating substantial time savings and unparalleled accuracy; and
c) the “last yard delivery” (delivery from the truck parked in front of the customer home to a delivery point proximate (i.e. just outside and within view of) the delivery vehicle, such as a package recipient's home front door) is typically done by a last yard drone carrying the package, with active guidance and support by the driver as needed to securely and accurately drop off the package at the front door (robotic and human labor).

Alternatively, some of the last yard deliveries can also occasionally be done by the driver manually, such as by walking while carrying the package, if special conditions require it (such as to unlock a gate, get a signature, interact with the customer, etc.).

A second alternative for the last yard delivery is to use a package delivery robot, typically a mobile robot that can carry packages and drop them off in front of the customer door.

The above division of labor may, in some circumstances, be optimal for a number of reasons, including:

Humans may be better at driving vehicles than robots or self-driving systems, and more free of regulatory constraints;

A Package Handling Robot is much faster and more accurate than a human at finding and picking packages from the cargo area—and also: the robot is able to do it while the truck is traveling. A human cannot drive a truck and pick packages at the same time.

The last yard drone (or the package delivery robot) is generally faster than a human at carrying a package from the truck to the customer door, and the driver can meanwhile get ready to drive to the next customer location.

The consequence of this division of labor are major time savings, major increase in productivity, major increase in deliveries per shift, hence lower cost per delivery, major stress reduction for the driver, better financial outcomes for the service provider company. It also increases the labor pool to hire drivers, because the driver does not need to be able to lift heavy packages or be a wizard at finding packages in the back of the truck.

Additional time and cost savings are achieved at the distribution center because with this new system the truck is not loaded manually anymore by the driver in a time-consuming and exhausting heavy-lifting manual operation, but instead by loading complete cribs or container full of delivery-route-sorted packages using forklifts or loading robots into the delivery vehicles.

### BRIEF DESCRIPTION OF THE DRAWINGS

FIG. 1 is a schematic cutaway perspective view of a Hybrid Delivery Vehicle (HDV) with an integrated drone station.

FIG. 2 shows a HDV equipped with roof solar panels.

FIG. 3 is a front perspective view of a delivery drone.

FIG. 4 is a rear perspective view of the delivery drone.

FIG. 5 is a side view of the delivery drone.

FIG. 6 is a front view of the delivery drone with open hinged lid.

FIG. 7 illustrates the delivery drone during a package delivery.

FIG. 8 is a perspective view of a drone propeller.

FIG. 9 is a side view of a HDV, in accordance with a second embodiment.

FIG. 10 is a front view of a smart container with integrated package delivery robot.

FIG. 11 is a top perspective view of the smart container of FIG. 10.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

A Hybrid Delivery System (HDS) is provided, embodiments of which may include the following components:

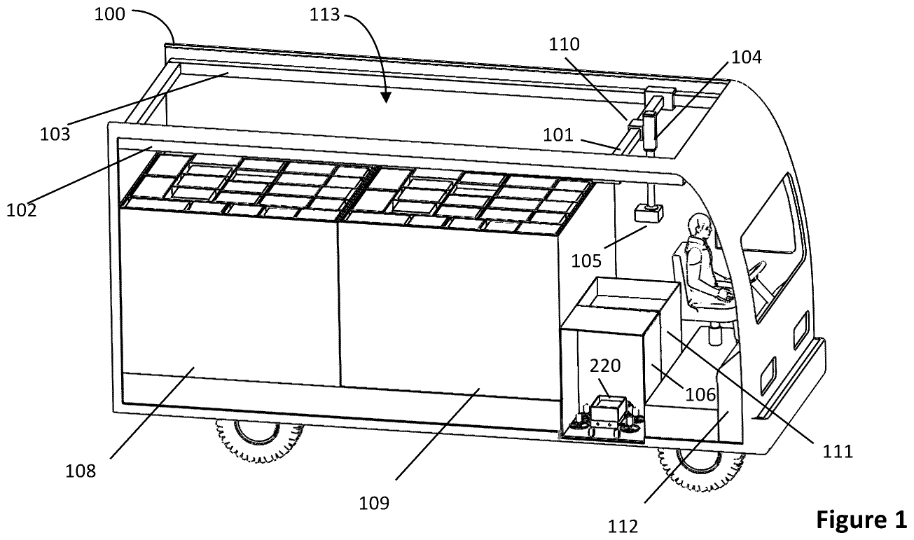

A Hybrid Delivery Vehicle (HDV) is shown in FIG. 1. The HDV 100 is a drivable delivery vehicle configured for e.g. traversing roadways, that can be powered by electricity, internal combustion engine or other means, with a preference for electric vehicles. In the illustrated embodiment, HDV 100 is configured for manual driving by a human driver; however, it is contemplated and understood that in alternative embodiments, HDV 100 may be partially or fully autonomous (i.e. self-driving).

The HDV 100 may be fully compatible with existing fleets of delivery vehicles, which can be retrofitted with all the equipment and features to convert a traditional delivery vehicle into an HDV 100. The HDV 100 is equipped with a Package Handling Robot 110, typically located inside a cargo area 113 of HDV 100, near the ceiling of the vehicle, which performs all cargo operations in the vehicle; thus, the driver may not be required to manually search for packages in the back of the truck at each stop and configure each drop-off manually. In some embodiments, package handling robot 110 is implemented using a cartesian robot, but many other types of robots can also be used for this purpose, such as robotic arms and many other robot types and architectures. The Package Handling Robot 110 provides a level of accuracy, repeatability, robustness, speed and reliability that is virtually impossible to achieve by human labor. The Package Handling Robot 110 is managed by a Computer Control System 112, which may be implemented within the HDV 100. In FIG. 1, Computer Control System 112 is implemented within a dashboard of HDV 100, although it is contemplated and understood that Computer Control System 112 could be implemented anywhere within the vehicle, externally to the vehicle and accessed via a data communications network, or via some combination of local and remotely-networked components. Under the management of Computer Control System 112, package handling robot 110 performs all cargo operations in the HDV, including but not limited to locating packages for next drop-off, picking them up, carrying them to the waiting drone and depositing them in the drone's bin to be ready for immediate drop-off upon arrival at the next destination. More generally, package handling robot 110 under control of computer control system 112 may be operable to search for, identify, pick, reorganize and transfer packages from one location to another location within HDV 100.

The Package Handling Robot 110 has a bridge 101 that can slide back and forth along the longitudinal rails 102 and 103, and is therefore able to reach any spot within the area, from the cabin to the back of the cargo area. A vertical actuator 104 is vertically deployable from the top of the partitioned cribs to the bottom of the cribs, enabling it to reach selectively inside each partition of the cribs under computer control to extract the right packages at the right time. For that purpose, the actuator has an end of arm tool configured to grasp and release packages. In some embodiments, the end of arm tool may include one or more suction cups, which are used to hold packages such as package 105 with a vacuum suction.

Occasionally certain packages that require human delivery can be transferred by the Package Handling Robot 110 from the crib to a bin 111 in the cabin near the driver, so that upon arrival the packages will be ready for the driver to quickly grab them before exiting ADV 100 to drop the package off at its final delivery location.

In preferred embodiments, a key feature in the actuator 104 is its ability to deploy vertically down to pick up a package inside a crib, and then retract vertically to lift the package without interference with the ceiling of the vehicle. Conventional cartesian robots in factories and warehouses are typically not be able to do this, because when they retract they project the lifting actuator a substantial distance above the bridge 101, which would cause a collision with the ceiling. Preferably, actuator 104 will not project above the bridge 101 when lifting objects, which enables this approach. Otherwise the vehicle would require an extremely high roof, which would not be practical in urban areas or most streets, since the truck would interfere with trees, lines, bridges, overpasses, etc. Thus, in preferred embodiments, actuator 104 extends only downwards, never upwards. That can be accomplished by using gravity in the downward deployment, and mechanical, pneumatic or other means in the upward retraction.

In accordance with one embodiment, the basic architecture of actuator 104 includes a set of tubes nested inside each other. The tubes can be cylindrical, square, rectangular or any other desired shape. The last tube, at the bottom of the stack of tubes, is connected by a belt, rope or similar means to a pulley located on the bridge of the overhead robot. The pulley is driven by an electric motor under robot control. To extend the actuator down, the motor would be turned so that the belt unwinds from the pulley, allowing the descent of the stack of tubes. The tubes have an innovative system of interacting stops which forces them to sequentially one by one follow the travel of the bottom tube in both upward or downwards movement. Whatever the bottom tube does, the other tubes copy, in perfect sequence and synchronization. That is the way the actuator gets deployed and retrieved. In deployment mode, the driving force is gravity and the pulley and motor act as a brake to control the speed of deployment, preventing excessive speed and shock. In retraction mode, the motor pulls up the set of tubes by winding up the belt around the pulley. Further details of such an actuator mechanism are described in further detail in Applicant's co-pending U.S. patent application Ser. No. 18/161,050, filed Jan. 28, 2023, the contents of which are incorporated by reference herein.

The HDV 100 preferably does not have shelves, drawers or other horizontal extraction structures in the cargo area to hold the packages in place while driving. Shelves and drawers may make the loading of packages into the HDV slow and difficult. Instead, HDV 100 uses only vertical partitions. Multiple packages can be stacked within a vertical partition. All extractions are purely vertical and therefore extremely simple and fast. Packages are loaded separately into cribs at the warehouse/distribution center. Preferably, packages are stacked within a vertical partition in anticipated order of delivery. Further examples of crib loading and related concepts are described below and also disclosed in Applicant's co-pending U.S. patent application Ser. No. 18/161,050, the contents of which are incorporated herein by reference.

The embodiment of FIG. 1 illustrates HDV 100 having an open cargo area into which two cribs (crib 108 and crib 109) are installed. Use of two cribs may facilitate easy loading of cribs into the vehicle, but of course it is also possible to use 1, 3 or even more cribs per delivery vehicle. Crib 108 and crib 109 are essentially each a partitioned box to retain and organize the packages, in delivery route sequence, within the cribs. The cribs can be easily inserted into or extracted from the HDV 100, which may have a substantially empty cargo area 113 before loading of crib 108 and crib 109. The cargo area 113 may be almost completely occupied by crib 108 and crib 109 when they are loaded into HDV 100, such as using a forklift or similar equipment. As a result, HDV 100 can be loaded with a high package density relative to the area of cargo area 113, and all packages can be loaded together into HDV 100 at the same time (inside the pre-loaded cribs) turning a time consuming and error prone manual loading process with heavy lifting by human labor into a simple and efficient robotized operation that takes only a few minutes.

### Cribs

In some embodiments, crib 108 and crib 109 in FIG. 1 are formed substantially as large boxes made of plastic, metal or other suitable material, with internal partitions. The cribs securely hold packages in a predetermined delivery route order inside the vehicle in a way that the packages cannot be accidentally shifted, shuffled, mingled, mixed, disturbed or altered in their sequence due to the vehicle movement, thereby always preserving the correct delivery route sequence.

The cribs are filled automatically with packages at the warehouse/distribution center (not at the vehicle) in delivery route order as determined by vehicle routing software, and then the full cribs are moved to HDV 100 typically by forklifts or by transportation robots and quickly inserted into the back of the vehicle. In some embodiments, such loading of crib 108 and crib 109 into cargo area 113 of HDB 100 can be accomplished very quickly, the operation being measured in seconds. Therefore, HDV 100 need not be immobilized for a long time while being loaded. Cribs can be loaded with packages continuously at a warehouse, so that full Cribs can always be ready to be inserted into the delivery vehicle as needed. In such embodiments, package loading need not delay the driver anymore. The driver need not have to manually load the vehicle anymore, unlike current practice, reducing physical strength and fitness requirements of drivers and reducing opportunities for driver injury during loading. Such solutions may therefore expand the hiring pool of drivers.

### Load Cell

The Load Cell is an automated crib loading system located at the distribution center or warehouse, which loads the packages into the Cribs in the correct routing sequence for optimized driving. The Load Cell includes a Package Handling Robot, which may be analogous to package handling robot 110 in HDV 100, but with the opposite function: instead of retrieving packages from the cribs, it loads packages into the cribs. The Load Cell can be standalone (for instance, in the parking lot of the distribution center), or inside the distribution center building or warehouse. The Load Cell automatically loads the packages into the cribs, which are then transferred fully-loaded in perfect optimized routing delivery sequence into the HDVs, saving a substantial amount of driver time and physical effort with improved accuracy and exertion/stress reduction for the driver. Further details and exemplary embodiments of the Load Cell are disclosed in Applicant's co-pending U.S. patent application Ser. No. 18/161,050, the contents of which are incorporated by reference.

### Drone Station and Solar Panels

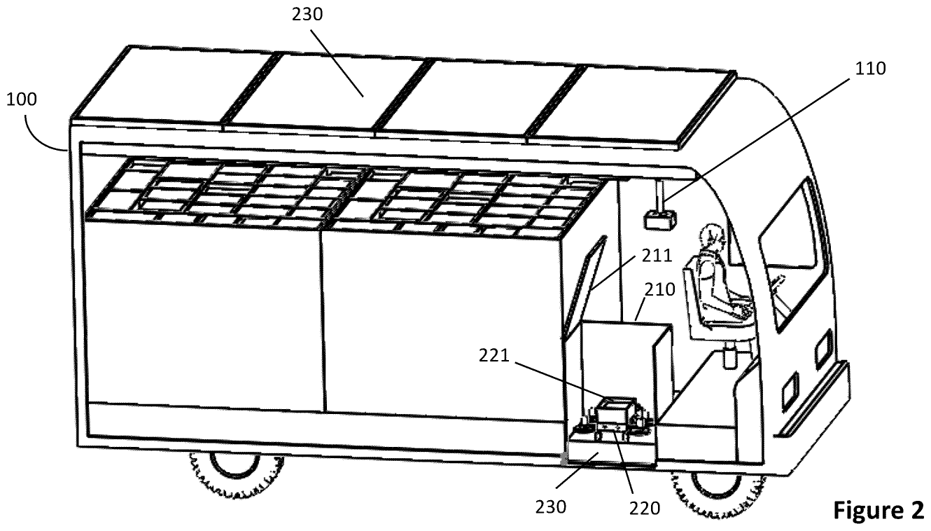

FIG. 2 is an alternative perspective view of HDV 100, illustrating further details of the vehicle roof and delivery drone arrangement. As shown in FIG. 2, one or more delivery drones 220 are housed in a drone station 210, which can be formed from a box made of plastic, metal or other material suitable for housing and protecting one or more drone robots 220. The drone station 210 is equipped with a cover 211, which can be electrically opened to allow the Package Handling Robot 110 to deposit package(s) into the top bin 221 of delivery drone 220. Most of the time the cover 211 remains closed, so that the drone noise will not disrupt the driver. However, in some embodiments, the cover 211 can be made of a thick, impact-resistant, safe transparent material to allow the driver to see what is going on inside the drone station when needed. Additionally or alternatively, a camera may be provided within drone station 210 to, inter alia, provide a driver with a view of activity inside the drone station 210.

Multiple drones 220 can be housed inside the drone station 210 by, e.g., making the drone station taller and providing shelves to stack the drones on top of each other. Alternatively, additional separate drone stations can be provided behind or beside drone station 210 or at other locations, such as in the back of the cargo area 113.

Preferably, delivery drone 220 is electrically-powered by an onboard rechargeable battery. In such embodiments, a charging station 230 may be provided inside or near the drone station 210 for each delivery drone 220 to enable the drone to be charged whenever it is inside drone station 210. Delivery drones 220 may be held in place by physical locking or retention mechanisms (which may utilize, e.g., magnetic or mechanical attachments) so the drones don't shift position due to vehicle movement during travel. The electrical contact with charging station 230 is maintained by interlocking mechanisms, insertion of pins into receptacles, deployable contacts, by spring force, by magnetic attraction or other means.

The location of drone station 210 inside HDV 100 has many advantages. It allows the driver to supervise the drone activity, which would be much harder to do if the drones were stationed, e.g., outside on the roof. Also, a drone station located on the roof of the vehicle may force the drones to fly at a height that in urban and suburban areas is replete with power lines, communication lines, posts, trees, signs and many other obstacles that invite collisions and potentially danger from cut lines and electrical shock to the driver or bystanders. Also, on the roof the drones (and the packages) would be exposed to the elements. Even though drones can be made water resistant to some extent, it is not desirable to have that continuous exposure if it can be easily avoided by stationing them inside the vehicle. Multiple locations for the drone station are available in the vehicle in addition to the one shown in FIGS. 1 and 2, all within the scope of this disclosure.

In addition, using the roof as a drone station would limit the vehicle roof surface from other uses. In some embodiments, solar panels 230 may be installed over all or a portion of the roof surface of HDV 100. Solar panels 230 can be operating continuously during a deployment of HDV 100, recharging batteries of HDV 100 to the extent HDV 100 is an electric battery powered vehicle and extending the vehicle's operating range. Additionally or alternatively, solar panels 230 can power package handling robot 110, delivery drone 220, as well as providing other services such as HVAC. Solar panels have made and continue making great advances in efficiency and output, and they can significantly extend range or power services that otherwise would reduce range. In addition, large deployments of HDV 100 with onboard solar panels may make a significant contribution to cleaner energy and less pollution.

The charging station 230 may contain a conventional battery charger, but it can also provide other advanced features, such as:
a charger for a capacitor or supercapacitor installed on delivery drone 220, which could provide sufficient power for a last yard delivery, preventing the drone from running out of power by recharging the capacitor or supercapacitor between deliveries, making it unnecessary to equip the drone with a large and heavy battery and increasing delivery drone payload instead;
enabling use of small, lightweight, low capacity single-delivery battery systems which are sufficient for a single last yard delivery and recharged between deliveries; and/or
a battery swapping mechanism, to keep the drone operational if its battery runs low, thereby keeping the drone in operation and avoiding interrupting the shift.

### The Last Yard Drone (LY-Drone)

As described above, during travel of HDV 100, delivery drone 220 is typically housed in drone station 210 next to the driver. The last yard delivery drone 220 is a drone focused specifically on the short distance between delivery truck and customer home, which is typically only a few yards away, and it is optimized for that specific function. It springs into action as soon as HDV 100 arrives at a delivery destination, exiting HDV 100 with one or more packages, preferably having been previously loaded into its top bin 221 by Package Handling Robot 110 during travel of HDV 100 to the delivery location. Delivery drone 220 drops off the package at the customer's door and rushes back to the vehicle. The LY drone delivery may be an extremely short and efficient trip.

Some embodiments of the delivery drone 220 may avoid certain objections to prior solutions that have discouraged implementation, including:
FAA regulations: in some embodiments, delivery drone 220 may be under driver control and not autonomous. In such embodiments, the driver can guide the drone to the exact desired drop-off point with radio control or similar means, while maintaining straight line of sight at all times, thereby complying with FAA regulations.
Privacy: the focused, very short trips taken by delivery drone 220 minimize any privacy concerns, traveling only across the property of the customer who requested the package.
Noise: the very short trip taken by delivery drone 220 doesn't require high speed (reducing the delivery time from 6 seconds to 2 second could be technically done, but it is unnecessary, even undesirable because of safety), therefore the propellers don't need to be spun at extreme speeds and the noise level can be kept low. In addition, significant improvements in drone design described hereinbelow can reduce noise even further.
Safety: delivery drone 220 can be equipped with a shroud made of thin plastic or metal wire or other suitable materials, completely surrounding the propellers, eliminating or minimizing risk of propeller injury to a human, pet or property. While there may be a small propeller efficiency reduction as a consequence of the shrouds, the short trip time and distance for delivery drone 220 ensures minimal impact in overall delivery efficiency.
Dual mode of transportation (air & ground): delivery drone 220 may be additionally equipped with wheels, which enable it to also travel on the ground when it makes more sense (busy areas, children or pets around, heavy winds or other special conditions) further reducing noise and the possibility of interfering with people or objects. In some embodiments, delivery drone 220 can readily switch back and forth between air and ground modes of travel.

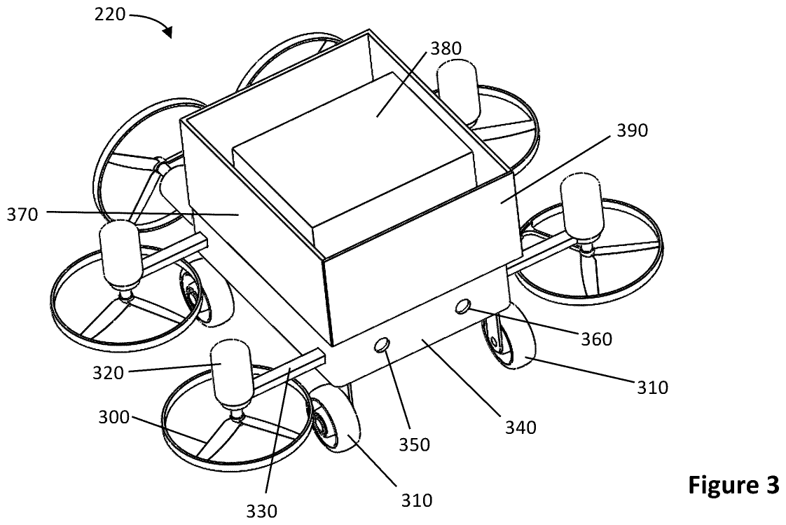

FIG. 3 is a perspective view of last yard delivery drone 220, in accordance with an exemplary embodiment. Delivery drone 220 is equipped with six propellers such as propeller 300, each propeller powered by an electric motor 320. Each electric motor 320 held in place by an arm 330 attached to base 340. The base has a camera 350 for machine vision and to take pictures confirming delivery, and a searchlight 360 for night shift work such as finding the house number. Bin 370 is basically a container for package 380, with a hinged lid 390 in front to facilitate delivery. The bin 370 can be optionally equipped with a top lid (not shown) to prevent the contents from getting wet. The bin can be opened electrically or by other methods. Delivery drone 220 further includes four wheels 310 rotatably mounted on the underside of delivery drone 220. In the embodiment of FIG. 3, wheels 310 are not powered, but delivery drone 220 may be propelled forward by operation of rear propellers 400 (e.g. with lift propellers 300 unpowered) while rolling on wheels 310. In other embodiments, one or more of wheels 310 may be powered (e.g. by onboard electric motors) to permit ground-based movements of delivery drone 220 potentially without operation of rear propellers 400.

While FIG. 3 illustrates an exemplary embodiment, it is contemplated and understood that the described drone architecture can be readily modified by, for example, changing the number of propellers or other features.

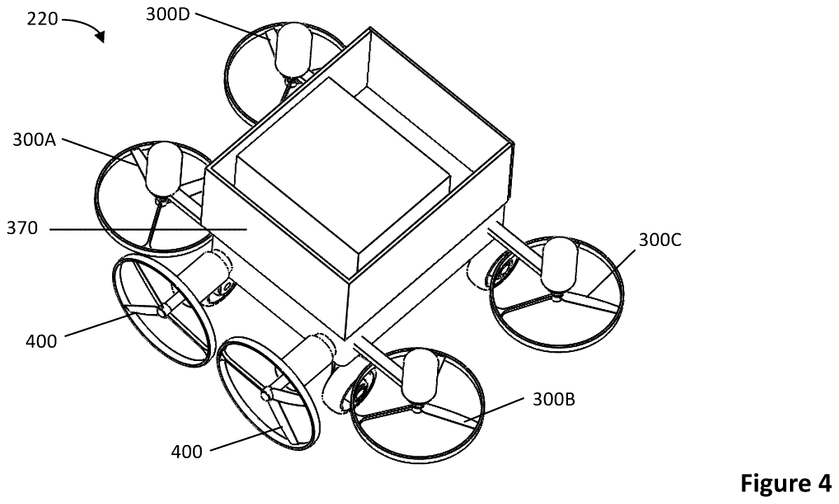

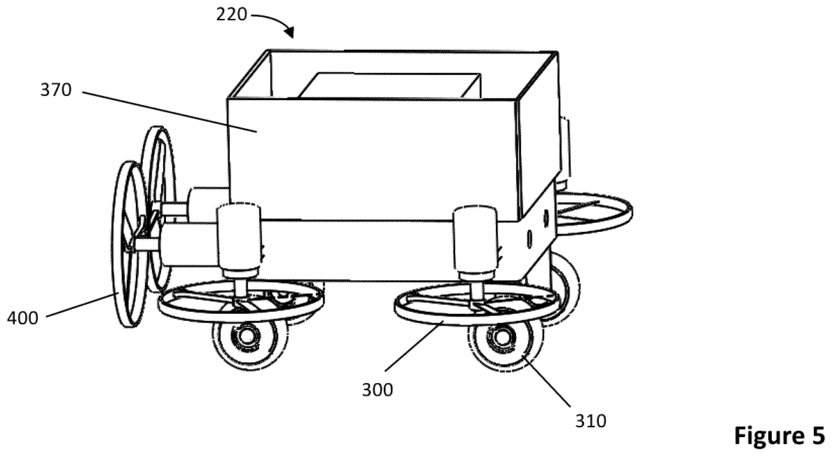

FIG. 4 is a top rear view of delivery drone 220 that shows the arrangement of propellers. The four lateral propellers 300 provide the lift for the drone, while two rear propellers 400 are oriented horizontally and provide horizontal propulsion, as well as an enhanced capability to turn sideways by varying the relative rotational speed between the two rear propellers 400. One of the advantages of this propeller architecture is the ability to fly keeping the drone parallel to the ground, rather than tilting for forward propulsion like helicopters and almost all drones do. Level flight is more energy efficient and can prevent payload shifting. Another advantage is the better controllability and stability of the drone. The propellers are pointing down to take advantage of the ground effect to increase lift, making this drone very well suited for flying or hovering close to the ground while performing deliveries. That said, many other drone configurations and propeller configurations are possible within the scope of systems described herein. For example, it is possible to change the number of vertical propellers and many other features of the described LY drone. FIG. 5 is a side view of delivery drone 220.

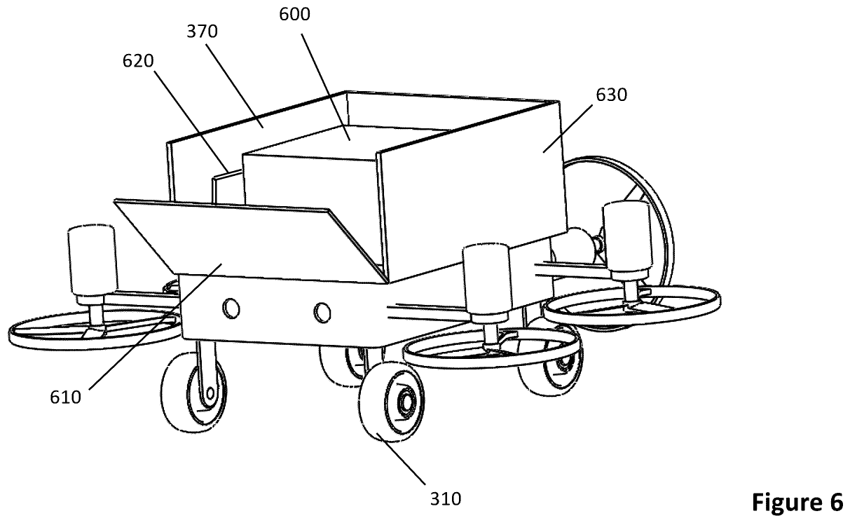

FIG. 6 is a front view of the last yard delivery drone 220 with its hinged front lid 610 partially open. The lateral plate 620 can be electrically or otherwise activated and it moves laterally towards a package 600 placed within bin 370, compressing the package 600 against the opposite wall 630 of the bin 370, thereby securing package 600 in place by pressure and friction during transportation. Front lid 610 can also have a display or a touchscreen LCD mounted on it, or on a top lid of bin 370 (not shown) or on any of the side walls or even on the drone base, to facilitate interactive communication with the receiving customer and obtain a signature confirming delivery if necessary.

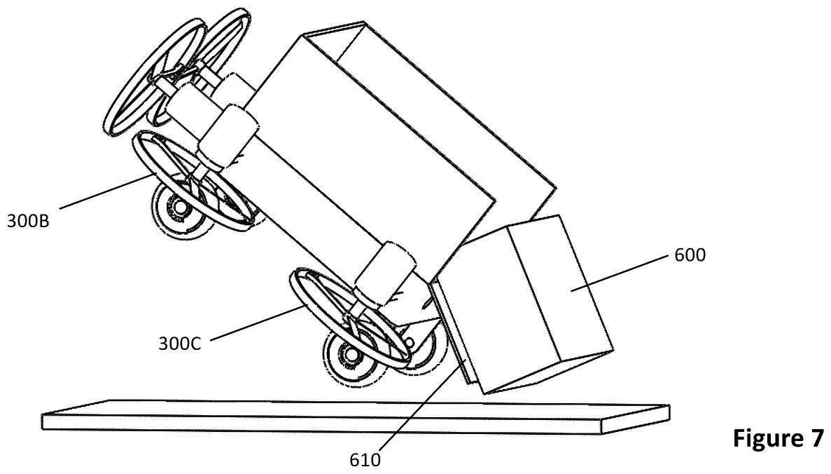

FIG. 7 shows delivery drone 220 delivering package 600 from the air. Delivery drone 220 briefly hovers at the point of delivery and tilts forward by spinning its rear lift propellers (300A and 300B) somewhat faster than front propeller (300C and 300D). Then the lid's locking mechanism is released (electrically or otherwise) and the lid 610 deploys forward (by gravity, electrically or otherwise). The package 600 slides down, using the lid as a downward ramp. Applicant sometimes refers to this delivery mechanism as a hummingbird delivery, and it can be extremely fast, efficient, simple, safe, reliable and with a very soft landing for the package.

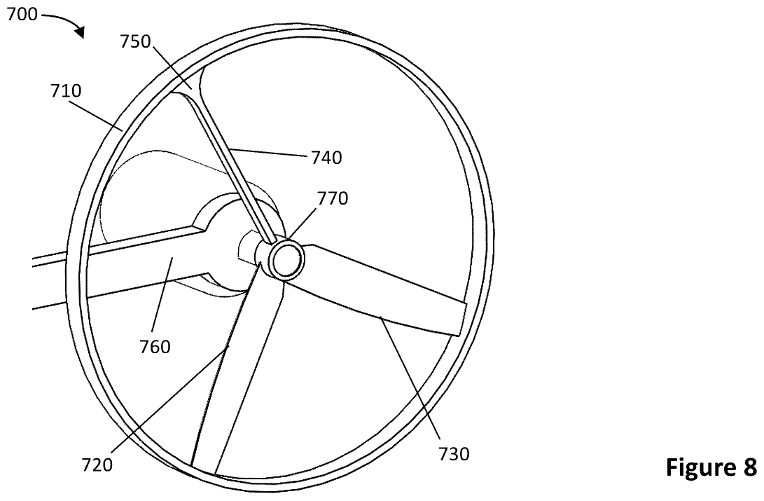

FIG. 8 shows one of the preferred embodiments of a propeller 700. The design of propeller 700 may be utilized for either or both of lift propellers 300 and propulsion propellers 400. The design of propeller 700 is intended to reduce noise, an important issue for drones in general but even more so for delivery drones operating in populated environments. This innovative propeller 700 has a ring 710 connecting together the tips of two blades (blade 720 and blade 730). An inner end of blade 720 and blade 730 is secured to a central propeller hub 770. Ring 710 can therefore act to stabilize the blades and reduce noise by minimizing propeller vibration.

Traditionally, for drone propellers with two blades, the blades are aligned symmetrically in a straight line, extending in opposite directions from a central hub. However, in the embodiment of FIG. 8, blade 720 and blade 730 are not aligned in a straight line, but instead are oriented asymmetrically, having uneven angular spacing (e.g. for a two-blade propeller, having one angular spacing significantly smaller than 180 degrees)—an arrangement that may further favor noise reduction. A radial support 740 is provided between hub 770 and ring 710, but its shape is not intended to create air flow or function as a propeller blade; rather, it is just a support for the ring 710, with an enlarged portion 750, serving as a counterbalancing mass, positioned where support 740 connects with ring 710 that provides a counterbalance for blades 720 and 730. Thus, radial support 740 may be, in some embodiments, thinner than blade 720 or blade 730 and not pitched relative to the plane of rotation for propeller 700. The balance can be further refined by drilling small holes into enlarged portion 750 or attaching small weights to enlarged portion 750 in a balancing machine. This propeller design with non-symmetrical blades stabilized by a ring support can provide significant acoustic advantages, which can be even further enhanced by increasing the distance between the propeller hub 770 and the surface of the support arm 760. Further noise reduction can be achieved by mounting the two blades 720 and 730 in separate planes, i.e. by varying the axial distance between each of blade 720 and 730, on the one hand, and support arm 760, on the other hand.

Many variations of the described architecture of the low noise propeller are possible, all within the scope of the disclosure. For example, the radial support 740 can be replaced by a third blade, which would somewhat increase noise but provide more air flow and lift, so it is a tradeoff. Greater numbers of blades may be used, in conjunction with ring 710 or not. Additionally or alternatively, a shroud surrounding all moving parts can be added, which would increase safety but somewhat reduce lift, also a tradeoff.

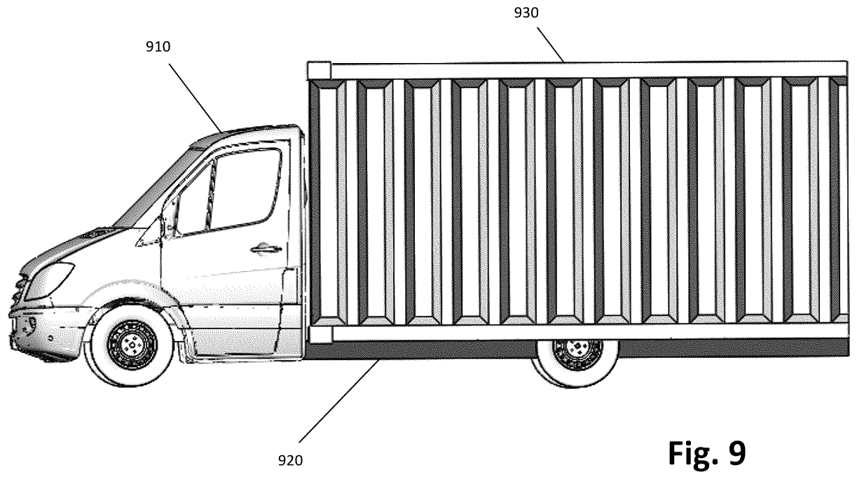

FIG. 9 shows another embodiment of a Hybrid Delivery Vehicle, HDV 900. Other than as described here and reflected in FIG. 9, the structure and operation of HDV 900 may be the same or analogous to that of HDV 100. The design of HDV 900 may be beneficial particularly for large scale deployments. While HDV 100 is illustrated using a relatively expensive van as the vehicle base, which may also be harder to customize, HDV 900 can be implemented using a small or medium size light truck (preferably but not necessarily a flatbed truck) plus a container (such as a typical shipping container used customarily in sea shipping) to hold the packages. As illustrated in FIG. 9, light truck 910 includes flatbed 920, with container 930 mounted thereon.

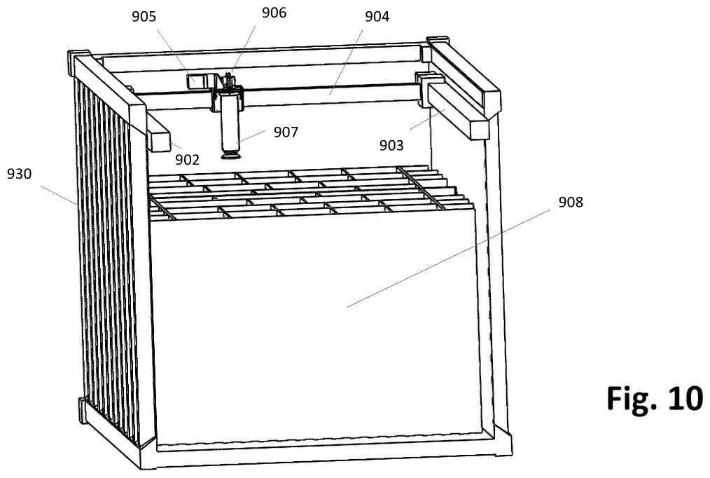

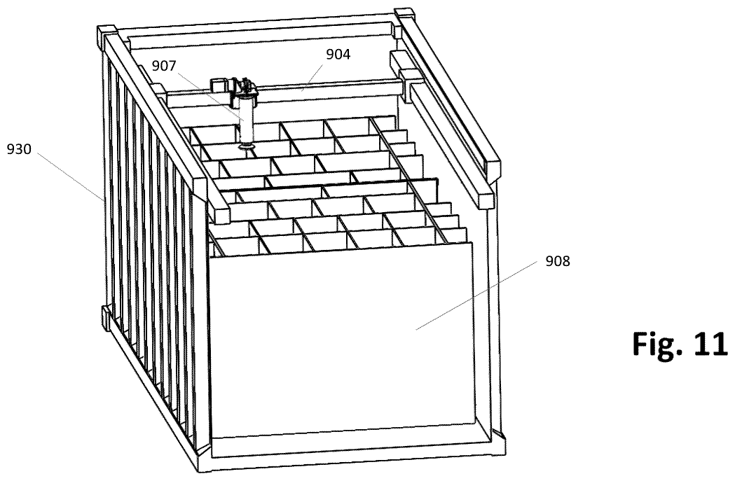

FIG. 10 illustrates further details of container 930, implementing an embodiment of a Smart Container System (SCS). Container 930 has a built-in small overhead robot to extract packages from its cargo area. The bridge 904 can slide along the rails 902 and 903, therefore being able to cover the entire inside area of the container. The vertical actuator 907 can slide along the bridge, therefore allowing the robot to extract packages from any position inside the SCS. The robot has a motor 905 to lift packages and a pulley 906 to control the speed of deployment and extraction of packages. The packages are stored in the CSC in the specific locations defined by the partition system 908. In this manner, the package handling robot system of container 930 is analogous to package handling robot 110, but installed directly within container 930 rather than being fixedly installed within the vehicle itself. FIG. 11 is a top perspective cutaway view of container 930 to provide further clarity.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of the invention or appended claims.

What is claimed:

1. A hybrid integrated delivery system comprising:
a drivable delivery vehicle having an open cargo area;
a package handling robot installed within the delivery vehicle and under control of a computer control system also installed within the delivery vehicle, the package handling robot being configured to search for, identify, pick, reorganize and transfer packages from one location to another location within the delivery vehicle;
one or more cribs removably installed in the delivery vehicle cargo area, each crib containing packages preloaded into a plurality of partitioned areas of the crib, the packages having been preloaded into the crib outside of the delivery vehicle in delivery route sequence;
a flying delivery drone having a bin for holding one or more packages, the delivery drone configured to transport the one or more packages from a drone station within the delivery vehicle to a package delivery location outside but proximate to the vehicle, and then return to the drone station; and
at least one drone station, which is a structure or area located in the vehicle, preferably inside the vehicle, where the drones can wait for the next delivery, while the drone station protects the driver from mechanical parts and from noise; and
wherein the computer control system is configured to cause the package handling robot to collect a package needed for a delivery route stop from the crib during transit of the delivery vehicle to the delivery route stop.

2. The hybrid integrated delivery system of claim 1, further comprising one or more solar panels mounted on a roof of the delivery vehicle to provide electrical power to the vehicle, wherein the package handling robot and delivery drone can be powered at least in part by the solar panels.

3. The system of claim 1, in which the flying delivery drone comprises a plurality of lift propellers, and one or more rear propellers oriented horizontally.

4. The system of claim 1, in which the computer control system is further configured to cause the package handling robot to deposit the package into either the delivery drone bin, or a driver bin within a cabin of the delivery vehicle and accessible to a driver of the delivery vehicle for manual transport to the delivery location.

5. The system of claim 1, in which the delivery drone is configured for manual piloting from the delivery vehicle to the delivery location by a driver of the delivery vehicle.

6. The system of claim 1 wherein the drone station comprises a retention mechanism configured to secure the delivery drone within the drone station while the delivery vehicle is traveling.

7. The system of claim 1, wherein the delivery drone comprises a rechargeable battery for powering the delivery drone during flight; and the drone station comprises a charging station for the drone.

8. The system of claim 3, wherein the delivery drone comprises a set of wheels mounted on the underside of the delivery drone, and wherein the delivery drone may transit over a ground surface by rolling propelled at least in part by the one or more rear propellers.

9. The system of claim 1, wherein the delivery drone bin comprises an open top, and a hinged front lid.

10. The system of claim 1, wherein the delivery drone comprises a plurality of propellers, each said propeller comprising a peripheral ring attached to tips of two or more blades.

11. The system of claim 10, wherein the two or more blades are oriented asymmetrically with uneven angular spacing therebetween.

12. The system of claim 10, wherein the two or more blades are offset from one another axially.

13. The system of claim 10, wherein each propeller further comprises a radial support extending between a propeller hub and the peripheral ring, and a counterbalancing mass positioned where the radial support joins the peripheral ring.

14. The system of claim 9, wherein the hinged lid is configured for release during package delivery, the hinged lid rotating downward to serve as a ramp for offloading of a package within the delivery drone bin.

15. The system of claim 14, wherein the drone is configured to tilt forward during said offloading of a package.

16. The system of claim 1, wherein the delivery vehicle is an autonomous vehicle.
